(19) United States
(12) Patent Application Publication
(10) Pub. No.: US 2009/0129833 A1
(43) Pub. Date: May 21, 2009

(54) Fixing Device

(76) Inventor: Hiroshi Kawasaki, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 12/083,890

(22) PCT Filed: Nov. 28, 2006
(86) PCT No.: PCT/JP2006/323683

§ 371 Date: Apr. 18, 2008

(30) Foreign Application Priority Data
Nov. 28, 2005 (JP) 2005-342190

(51) Int. Cl. G03G 15/20

(52) U.S. Cl. 399/328

(57) ABSTRACT

[Object] To provide a fixing device in which thermal energy required for fixing a toner can be reduced to a large extent, a rising time for the fixation after energization is shortened, and the energization is not required during standby time.

[Means for Solution] The fixing device is characterized by including: a preliminary fixing member A for pressurizing a toner attached to a surface of a recording medium in a thickness direction of the recording medium to preliminarily fix the toner onto the recording medium so as to remove an air existing between toner particles; and a main fixing member B for pressurizing the preliminarily fixed toner in the thickness direction of the recording medium, and for simultaneously heating and fusing the toner from a back surface side of the recording medium, to thereby mainly fix the toner onto the recording medium.

### TECHNICAL FIELD

The present invention relates to a fixing device used for image forming in an electronic copying machine, a laser printer, a facsimile machine, and the like.

### BACKGROUND ARTS

In general, in an electronic copying machine, a laser printer, a facsimile machine, and the like, a toner is attached to a recording medium such as paper by an electrostatic recording system provided in such an apparatus, and then heated by a fixing device, whereby toner powder is fused on the recording medium to be fixed onto the recording medium (see Patent Document 1).

Patent Document 1: JP 05-210331 A

Specifically, in an electronic copying machine, a laser printer, a facsimile machine, and the like, as means for attaching toner powder to a recording medium such as paper by an electrostatic recording system provided in such an apparatus, and then heating the toner powder to be fused and fixed, as shown in FIG. 4, a heat roller fixing system is generally employed.

Referring to FIG. 4, a general structure of a conventional laser printer will be described.

First, a recording medium formed of a sheet having a predetermined size, which is pulled out from a sheet containing tray 101, is transported along a transport path 102 to enter an image forming mechanism 103. Powder-like toner is supplied from a toner tank 104 to a drum 107 through a developing roller 105. In this case, the toner is attached only to a part of the drum 107, which is charged by an electrostatic recording portion 106 for image formation, and then transferred onto the recording medium which has entered. Note that, in a circumferential direction of the drum 107, a removal mechanism 109 for removing a residual toner remaining after the transfer and a static eliminating roller 108 for eliminating electric charge are disposed in the stated order. The recording medium onto which the toner is thus transferred then enters a toner fixing member 211. In the toner fixing member 211, a heating roller 213 is heated by thermal energy generated by a heat generating heater 212 incorporated therein, and in a nip area 215 formed with an opposing roller 214, the toner powder on the recording medium is heated and fused to be fixed. After that, the recording medium is transported out of the toner fixing member 211 while being cooled, and delivered onto a delivery tray 124 by delivery rollers 207.

### DISCLOSURE OF THE INVENTION

### Problem to be Solved by the Invention

However, in the toner fixing member 211, the heat generating heater 212 and the drum-like heating roller 213 are used as described above, which makes it difficult to raise temperature rapidly. For this reason, there is an inconvenience in that, in a case where power for the apparatus is not supplied during the fixation, after supply of power is started, the fixation cannot be performed for a few minutes. Once the power is supplied, it is necessary to heat the heating roller 213 in a state where the power is always turned on because it is unclear when the fixation is to be performed, which poses a problem of a large energy loss.

The present invention has been made in view of the above-mentioned points, and an object of the present invention is to provide a fixing device which is capable of greatly reducing thermal energy required for fixing a toner, has a shorter rising time after energization for the fixation, and which does not require the energization during standby time.

### Means for Solving the Problem

In order to achieve the above-mentioned object, according to a first aspect of the present invention, a fixing device is characterized by including: a preliminary fixing member for pressurizing a toner attached to a surface of a recording medium in a thickness direction of the recording medium to preliminarily fix the toner onto the recording medium so as to remove an air existing between toner particles; and a main fixing member for pressurizing the preliminarily fixed toner in the thickness direction of the recording medium, and for simultaneously heating and fusing the toner from a back surface side of the recording medium, to thereby mainly fix the toner onto the recording medium.

With the above-mentioned structure, in the preliminary fixing member, the toner on the recording medium is preliminarily fixed in a state where the air existing between the particles is removed, whereby scattering of the toner is prevented, and a density of the toner particles becomes higher, which results in improving a heat transfer efficiency to a large extent. Next, in the main fixing member, the heat applied from the back surface side of the recording medium is transferred not through a space but through the recording medium itself, so the heat transfer efficiency becomes extremely higher. By the thermal energy thus transferred from the back surface side to the front surface side of the recording medium with high heat transfer efficiency, the toner preliminarily fixed to the front surface side is heated. The toner itself is in a state of containing no air and having a high heat transfer efficiency, so the toner is heated and fused with high efficiency even by low thermal energy. Simultaneously with the fusing, the toner is pressurized in a thickness direction of the recording medium, so a thickness of the toner is further compressed, and the toner is heated with high heat transfer efficiency to be attached to the recording medium, and is reliably fixed thereto.

Further, according to a second aspect of the present invention, the fixing device is characterized in that the preliminary fixing member includes: a pair of preliminary fixing rollers for nipping and transporting the recording medium; and a recording medium pressurizing mechanism for applying a mechanical pressure to the preliminary fixing rollers to generate a nip pressure.

With the above-mentioned structure, the toner pressurized by the pair of preliminary fixing rollers is preliminarily fixed onto the surface of the recording medium in the state where the air existing between the toner particles is removed, thereby being prevented from scattering from the recording medium. Further, a pressurizing force required for the preliminary fixation may be large enough to remove the air existing between the toner particles. As compared with a conventional case of performing the pressurization and the heating at the same time, the toner can be preliminarily fixed with a small pressurizing force.

Further, according to a third aspect of the present invention, the fixing device is characterized in that the preliminary fixing rollers include: a pair of small-diameter rollers for nipping and transporting the recording medium; and a large-diameter roller brought into contact with an outer periphery of each of the small-diameter rollers in parallel for pressing each of the small-diameter rollers so as to apply a nip pressure.

With the above-mentioned structure, the pressurizing force is applied to each of the small-diameter rollers by the large-diameter roller, thereby enabling the preliminary fixation. Further, a linear pressure as a nip pressure between the small-diameter rollers can be easily increased. Accordingly, the size of the preliminary fixing member can be reduced.

Further, according to a fourth aspect of the present invention, the fixing device is characterized in that the main fixing member includes: a thermal head for heating the recording medium from a back surface side; and a platen roller for nipping the recording medium with the thermal head to apply a pressing force.

With the above-mentioned structure, the recording medium is heated from the back surface side by the thermal head, whereby the toner can be reliably fused and mainly fixed. Specifically, by employment of a structure in which the thermal head is brought into contact with the back surface of the recording medium so as to apply heat from the back surface, a toner image is not abraded by the thermal head, with the result that a clearer image can be obtained. Further, rising of the heat generation by the thermal head after the energization is rapid, so standby energization is unnecessary. The energization is performed only at the time of fixation to generate heating energy, and only a part on the recording medium, which requires heating, is heated, whereby energy consumption of the apparatus can be reduced to a large extent, and an energy efficiency can be more increased as compared with a conventional fixing device.

Further, according to a fifth aspect of the present invention, the fixing device is characterized in that the thermal head is formed so as to be contactable/separable with respect to the platen roller.

With the above-mentioned structure, the thermal head is brought into contact with the platen roller only when the recording medium enters the main fixing member so as to perform a heating operation, thereby enabling fixation of the toner.

### EFFECTS OF THE INVENTION

The fixing device according to the present invention is structured and operates as described above, and has excellent effects in that thermal energy required for fixing a toner can be reduced to a large extent, a rising time for the fixation after energization can be shortened, and the energization is not required during standby time.

### BRIEF DESCRIPTION OF THE DRAWINGS

FIG. 1 A block diagram of a laser printer to which an embodiment of a fixing device according to the present invention is applied.

FIG. 2 A side view of a preliminary fixing member according to the present invention.

FIG. 3 A side view of a main fixing member according to the present invention.

FIG. 4 A block diagram of a laser printer showing a conventional heat roller fixing system.

### BEST MODE FOR CARRYING OUT THE INVENTION

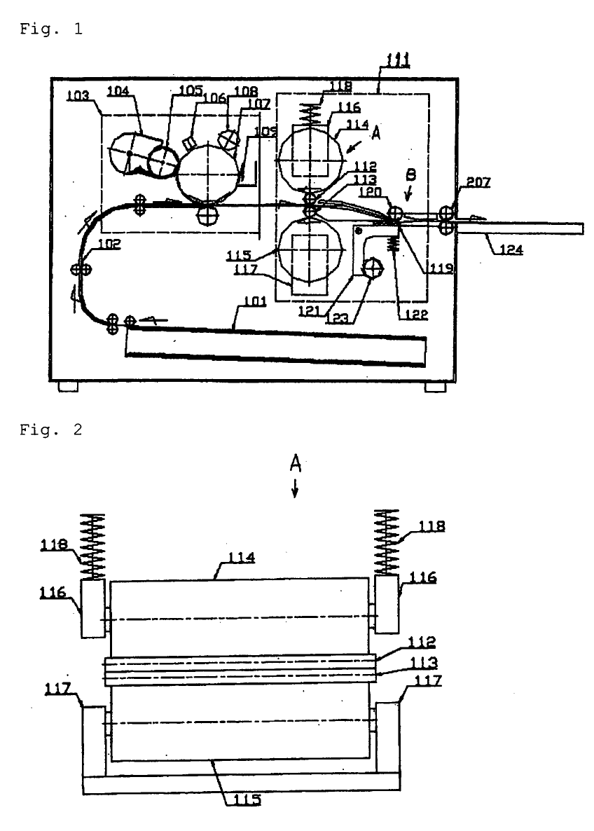

Next, an embodiment of the present invention will be described with reference to FIGS. 1 to 3.

FIG. 1 shows an example in which a fixing device according to the present invention is applied to a laser printer shown in FIG. 4. In FIG. 1, a portion from a sheet containing tray 101 to an image forming mechanism 103 is formed in a similar manner as in a conventional typical laser printer illustrated in FIG. 4, so a description thereof will be omitted.

The fixing device 111 according to the present invention is disposed at a downstream side in a transport direction (direction indicated by an arrow of FIG. 1) of a recording medium (not shown) with respect to the image forming mechanism 103. At an upstream side in the transport direction, there is disposed a preliminary fixing member A for pressurizing a toner attached to a surface of the recording medium in a thickness direction of the recording medium to preliminarily fix the toner onto the recording medium so as to remove an air existing between toner particles. At the downstream side in the transport direction, there is disposed a main fixing member B for pressurizing the preliminarily fixed toner in the thickness direction of the recording medium and for heating and fusing the toner from a back surface side of the recording medium, to thereby mainly fix the toner onto the recording medium.

In the preliminary fixing member A, which is one of the fixing members, as shown in FIGS. 1 and 2, as a pair of preliminary fixing rollers for nipping and transporting the recording medium, there are provided a pair of small-diameter rollers 112 and 113 made of metal, for nipping and transporting the recording medium, and a pair of large-diameter rollers 114 and 115 which are made of metal and brought into contact with an outer periphery of each of the small-diameter rollers 112 and 113 in parallel, to thereby press the small-diameter rollers so as to apply a nip pressure to the recording medium. The large-diameter rollers 114 and 115 are rotatably supported by bearings 116 and 117, respectively. The bearing 116, which is one of the bearings, is provided with a pressure spring 118 for pressurizing the large-diameter roller 114 and the small-diameter roller 112 against the opposing small-diameter roller 113 and large-diameter roller 115. The pressure spring 118 forms a recording medium pressurizing mechanism for applying a mechanical pressure to the preliminary fixing rollers 112, 113, 114, and 115 to generate a nip pressure for the recording medium. Note that, in order to prevent only a small portion of the toner from attaching to the small-diameter rollers 112 and 113 themselves when the recording medium passes between shafts of the small-diameter rollers 112 and 113 while being pressed, each surface of the rollers 112, 113, 114, and 115 forming the preliminary fixing rollers may be coated with a fluorine resin as disclosed in JP 59-198118 A.

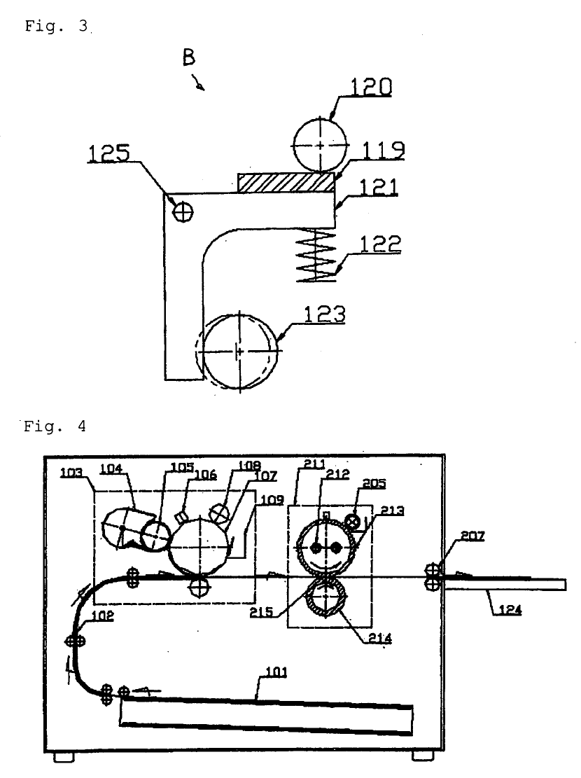

As shown in FIGS. 1 and 3, the main fixing member B, which is the other of the fixing members, includes a thermal head 119 for heating the recording medium from a back surface side, and a platen roller 120 made of rubber, for nipping the recording medium with the thermal head 119 to apply the pressure force. In the thermal head 119, a large number of heating elements (not shown) are formed at a pitch of, for example, 100 μm. The thermal head 119 is fixed to a swinging tip end of a link member 121, which has an L-shaped cross section and swings with a rocking shaft 125 as a center by an eccentric roller 123, so as to face the platen roller 120, and is elastically pressed against the platen roller 120 by a spring 122 disposed on a rear surface side of the link member 121. Through rotation of the eccentric roller 123, the thermal head 119 is contacted/separated to/from the platen roller 120. In the main fixing member B, the toner preliminarily fixed onto the recording medium is heated by the thermal head 119 from the back surface side of the recording medium for the following reason. If a head heating element of the thermal head 119 is brought into contact with the surface of the recording medium, the head heating element is pressed against the surface of the recording medium by the spring 122 with a pressing force of about 200 to 300 g/cm in linear pressure, and the surface is abraded. Accordingly, a toner layer is scraped off and a clear image cannot be obtained. In other words, according to the embodiment, by employment of a structure in which the thermal head 119 is brought into contact with the back surface of the recording medium to be heated from the back surface, a toner image is not abraded by the thermal head 119, with the result that a clearer image can be obtained.

Next, operations of the present invention will be described.

First, the recording medium having the toner electrostatically attached thereto in the image forming mechanism 103 enters the fixing device 111 according to the present invention.

In the fixing device 111, first, the recording medium passes between the small-diameter rollers 112 and 113 serving as the preliminary fixing rollers of the preliminary fixing member A. When passing between the small-diameter rollers 112 and 113, the recording medium is pressed in the thickness direction of the recording medium at a pressure in a range of 40 Kg to 50 Kg by an elastic force of the pressure spring 118. As a result, a toner powder layer which is merely mounted on the recording medium is crushed by the pressure on the surface. In other words, an air existing between particles of the toner powder is removed by the pressure, and a thickness of the toner layer is reduced and compressed. As a result, an adhesion of the toner with respect to the recording medium is reinforced. Even when the surface is slightly abraded, the toner is hardly scraped off from the recording medium, and scattering thereof is prevented. Further, a pressurizing force required for the preliminary fixation may be large enough to remove the air existing between the toner particles. As compared with a conventional case of performing the pressurization and the heating at the same time, the toner can be preliminarily fixed with a small pressurizing force. In addition, the large-diameter rollers 114 and 115 apply the pressurizing force to the small-diameter rollers 112 and 113, respectively, so the linear pressure as the nip pressure between the small-diameter rollers 112 and 113 can be easily increased. Accordingly, the size of the preliminary fixing member can be reduced.

The toner thus formed in the image forming portion 103 so as to correspond to a print image is not heated in the preliminary fixing member A but is preliminarily fixed onto the recording medium.

Subsequently, the recording medium having the toner preliminarily fixed thereto is transported to the main fixing member B.

In the main fixing member B, the thermal head 119 is separated from the rubber roller 120 by the eccentric roller 123 and the link member 121 until a leading edge of the recording medium reaches the thermal head 119. The eccentric roller 123 rotates at a timing when the leading edge of the recording medium reaches a heating element portion of the thermal head 119. Then, the link member 121 swings with the rocking shaft 125 as a center, and the thermal head 119 is brought into contact with the rubber roller 120, whereby a pressing force of about 200 to 300 g/cm in linear pressure is applied by the spring 122. At almost the same time when the thermal head 119 and the rubber roller 120 are brought into contact with each other, the heating elements of the thermal head 119 are energized to heat the recording medium from the back surface side.

In this case, in the preliminary fixing member A, the toner on the recording medium is preliminarily fixed in the state where the air existing between the toner particles is removed, so the scattering of the toner is prevented. In addition, the density of the toner particles becomes higher, so the heat transfer efficiency is improved to a large extent. Further, in the main fixing member B, the heat applied from the back surface side of the recording medium is transferred not through a space but through the recording medium itself, so the heat transfer efficiency becomes extremely higher. By the thermal energy thus transferred from the back surface side to the front surface side of the recording medium with high heat transfer efficiency, the toner preliminarily fixed onto the front surface side is heated. The toner itself is in a state of containing no air and having a high heat transfer efficiency, so the toner is heated and fused with high efficiency even by low thermal energy. By employment of a structure in which the thermal head 119 is brought into contact with the back surface of the recording medium so as to apply heat from the back surface, the toner image is not abraded by the thermal head 119, with the result that a clearer image can be obtained. Simultaneously with the fusing, the toner is pressurized by the thermal head 119 and the rubber roller 120 in the thickness direction of the recording medium, so the thickness of the toner is further compressed, and the toner is heated with high heat transfer efficiency to be attached to the recording medium, and is reliably fixed thereto. Further, the rising of the thermal head 119 after the energization is rapid, so standby energization is unnecessary. The energization is performed only at the time of fixation to generate exothermic energy, and only a part on the recording medium, which requires heating, is heated, whereby energy consumption of the apparatus can be reduced to a large extent, and the energy efficiency can be more increased as compared with a conventional fixing device.

Upon completion of main fixation for a sheet of recording medium, through rotation of the eccentric roller 123, the thermal head 119 is spaced apart from the rubber roller 120 to stop energization of the heating elements, and waits for the subsequent main fixation.

In this manner, according to the fixing device 111 of the present invention, pre-heating which is required in a conventional electronic copying machine, laser printer, facsimile machine, and the like, becomes unnecessary. By performing a heating operation for the recording medium only when the recording medium enters the main fixing member, the fixation can be performed. Accordingly, a fixing operation with an extremely high efficiency can be realized.

Further, it is generally said that power consumption required for pre-heating prior to the fixation of a conventional heat roller fixing system as shown in FIG. 4 is four times as large as power consumption required for the fixation. Accordingly, in the fixing device 111 of the present invention, the fixation can be performed only by heating executed during the fixation, so the fixation can be performed with power of about 20% of that of a conventional case, whereby the energy can be saved by about 80%.

Note that the present invention is not limited to the above embodiment, but various modifications can be made, if necessary. For example, a thermal head as disposed in JP 3713274 B can be applied. Further, as disclosed in JP 10-157178 A and JP 3567241 B, heat generated by the thermal head is applied to a heating element with an appropriate magnitude of power according to a temperature state of the thermal head, or only a toner attached portion is selectively heated instead of applying the generated heat to the entirety of the recording medium, thereby making it possible to further increase the efficiency.

### INDUSTRIAL APPLICABILITY

According to a fixing device of the present invention, as compared with a conventional heat roller fixing system generally employed, temperature only during fixation can be raised rapidly, thereby making it possible to provide a fixing device capable of starting quickly. Accordingly, fixing a toner can be performed with power consumption of about 10 to 20% of that of a conventional case, which is effective from a viewpoint of energy saving, and it is likely that a large effect can be attained in a conventional electronic copying machine, laser printer, and the like which have an extremely large power consumption.

1. A fixing device, comprising:
a preliminary fixing member for pressurizing a toner attached to a surface of a recording medium in a thickness direction of the recording medium to preliminarily fix the toner onto the recording medium so as to remove an air existing between toner particles; and
a main fixing member for pressurizing the preliminarily fixed toner in the thickness direction of the recording medium, and for simultaneously heating and fusing the toner from a back surface side of the recording medium, to thereby mainly fix the toner onto the recording medium.

2. The fixing device according to claim 1, wherein the preliminary fixing member comprises:
a pair of preliminary fixing rollers for nipping and transporting the recording medium; and
a recording medium pressurizing mechanism for applying a mechanical pressure to the preliminary fixing rollers to generate a nip pressure.

3. The fixing device according to claim 2, wherein the preliminary fixing rollers comprise:
a pair of small-diameter rollers for nipping and transporting the recording medium; and
a large-diameter roller brought into contact with an outer periphery of each of the small-diameter rollers in parallel for pressing each of the small-diameter rollers so as to apply a nip pressure.

4. The fixing device according to claim 1, wherein the main fixing member comprises:
a thermal head for heating the recording medium from a back surface side; and
a platen roller for nipping the recording medium with the thermal head to apply a pressing force.

5. The fixing device according to claim 4, wherein the thermal head is formed so as to be contactable/separable with respect to the platen roller.
